(19) United States
(12) Patent Application Publication
(10) Pub. No.: US 2020/0212375 A1
(43) Pub. Date: Jul. 2, 2020

(54) BATTERY CASE AND BATTERY

(71) Applicant: SAMSUNG ELECTRONICS CO., LTD., Suwon-si (KR)

(72) Inventors: Hye Jeong LEE, Suwon-si (KR); Kyeong PANG, Suwon-si (KR); In Su LEE, Hwaseong-si (KR); In KIM, Suwon-si (KR); In Ki KIM, Hwaseong-si (KR); Eun Sung LEE, Hwaseong-si (KR); Song Won HYUN, Yongin-si (KR); Sung Dug KIM, Suwon-si (KR)

(21) Appl. No.: 16/726,524

(22) Filed: Dec. 24, 2019

(30) Foreign Application Priority Data
Dec. 26, 2018 (KR) 10-2018-0169826

(51) Int. Cl. H01M 2/02; C08L 23/06; C09K 19/38

(52) U.S. Cl. CPC H01M 2/0242; H01M 2/024; H01M 2/0262; C08K 3/042; C08L 23/06; C09K 19/38; C08L 2207/062; H01M 2/0265

(57) ABSTRACT

A battery case including a container configured to house an electrode assembly. The container includes a bottom wall and a plurality of side walls, the bottom wall and the side walls are integrated to have an open side opposite to the bottom wall, and which provides a space for housing the electrode assembly. The container includes a composite of a base polymer, a carbon-based filler, and an oligomer or a polymer that is dissolved in a solvent having a solubility parameter of about 15 MPa^{1/2} to about 30 MPa^{1/2}, and the oligomer or polymer has an amino group or a hydrophobic functional group. The battery case has a water vapor transmission rate (WVTR) of less than about 0.07 g/m²/day measured at a thickness of 1 mm, at 38° C., and relative humidity of 100% according to ISO 15106 or ASTM F1249, and a battery including the battery case.

### CROSS-REFERENCE TO RELATED APPLICATION

This application claims priority to Korean Patent Application No. 10-2018-0169826 filed in the Korean Intellectual Property Office on Dec. 26, 2018, and all the benefits accruing therefrom under 35 U.S.C. § 119, the entire content of which is herein incorporated by reference.

### BACKGROUND

### 1. Field

This disclosure relates to a battery case and a battery.

### 2. Description of the Related Art

Research on an electric vehicle (EV) using at least one battery system to supply a part of or entire part of motive power is of active interest. The electric vehicle exhibits greater fuel efficiency, e.g., a hybrid EV, and discharges lower emissions and less contamination to the environment compared to a traditional vehicle operated by an internal combustion engine. Some electric vehicles using electricity use no gasoline at all or obtain entire motive power from electricity, e.g., from an electric battery. As research on the electric vehicle continues, a requirement for an improved motive power source for an electric vehicle, for example, an improved battery module is of increasing interest.

An electric vehicle that uses electricity for at least a part of motive power may obtain electricity from a plurality of individual battery cell packed as a battery module. For example, a plurality of lithium ion battery cells or cell elements may be included in the battery module. Top performance of lithium ion battery cells or cell elements and the battery module may require operation at higher temperatures, and thus, may be packed with a material for cooling. In addition, the lithium ion battery cell elements are particularly sensitive to oxygen or moisture, and thus, may be packed in a moisture-sealing metal housing. However, the metal housing has design limitations in terms of shape due to restrictions with metal manufacture. Accordingly, a battery case and a method of manufacturing a battery module capable of solving issues of heat management, moisture transmission, and the like, and being of relatively low cost is needed.

### SUMMARY

An embodiment provides a battery case having improved moisture transmission resistivity, mechanical properties, and heat dissipation properties.

Another embodiment provides a battery including the battery case.

In an embodiment, a battery case includes a container configured to house an electrode assembly. The container includes a bottom wall and a plurality of side walls, the bottom wall and the side walls are integrated to have an open side opposite the bottom wall and to provide a space for housing the electrode assembly. The container includes a composite of a base polymer, a carbon-based filler, and an oligomer or a polymer that is dissolved in a solvent having a solubility parameter of about 15 MPa^{1/2} to about 30 MPa^{1/2}, and the oligomer or polymer has an amino group or a hydrophobic functional group. The battery case or the composite has a water vapor transmission rate (WVTR) of less than about 0.07 grams per square meter per day (g/m²/day) measured at a thickness of 1 millimeter (mm), at 38° C., and relative humidity of 100% according to ISO 15106 or ASTM F1249.

The base polymer may include polycarbonate, polyolefin, polyvinyl, polyamide, polyester, polyphenylene sulfide (PPS), polyphenylene ether, polyphenylene oxide, polystyrene, polyamide, a polycyclic olefin copolymer, an acrylonitrile-butadiene-styrene copolymer, a liquid crystal polymer (LCP), mixture thereof, an alloy thereof, or a copolymer thereof.

The base polymer may include a high density polyethylene (HDPE) or a liquid crystal polymer (LCP).

The liquid crystal polymer may include a liquid crystal aromatic polyester including a structural unit represented by Chemical Formula 1; a structural unit represented by Chemical Formula 2 and a structural unit represented by Chemical Formula 3; or a structural unit represented by Chemical Formula 1, a structural unit represented by Chemical Formula 2, and a structural unit represented by Chemical Formula 3:

*-(—(C═O)—Ar¹—O—)-* Chemical Formula 1

*-(—(C═O)—Ar²—(C═O)—)-* Chemical Formula 2

*-(—O—Ar³—O—)-* Chemical Formula 3

In Chemical Formulae 1 to 3,

Ar¹, Ar², and Ar³ are each independently a group including a substituted or unsubstituted C6 to C30 aromatic ring group, for example, a substituted or unsubstituted C6 to C30 single aromatic ring group, a condensed ring of two or more substituted or unsubstituted C6 to C30 aromatic ring groups, or a group including two or more substituted or unsubstituted C6 to C30 aromatic ring groups that are linked by a single bond, —O—, —C(═O)—, —C(OH)₂—, —S—, or —S(O)₂—.

The liquid crystal polymer may include a liquid crystal aromatic polyamide including a structural unit represented by Chemical Formula 4; a structural unit represented by Chemical Formula 5 and a structural unit represented by Chemical Formula 2; or a structural unit represented by Chemical Formula 4, a structural unit represented by Chemical Formula 5, and a structural unit represented by Chemical Formula 2:

*-(—(C═O)—Ar⁴—NH—)-* Chemical Formula 4

*-(—NH—Ar⁴—NH—)-* Chemical Formula 5

*-(—(C═O)—Ar²—(C═O)—)-* Chemical Formula 2

In Chemical Formula 4, Chemical Formula 5, and Chemical Formula 2,

Ar⁴, Ar^{y}, and Ar² are each independently a group including a substituted or unsubstituted C6 to C30 aromatic ring group, for example, a substituted or unsubstituted C6 to C30 single aromatic ring group, a condensed ring of two or more substituted or unsubstituted C6 to C30 aromatic ring groups, or a group including two or more substituted or unsubstituted C6 to C30 aromatic ring groups that are linked by a single bond, —O—, —C(═O)—, —C(OH)₂—, —S—, or —S(O)₂—.

The carbon-based filler may include graphite, graphene, a graphite nanoplate, or a combination thereof.

The carbon-based filler may have a plate-like shape having an aspect ratio of greater than or equal to about 10.

The hydrophobic functional group of the oligomer or polymer may be an aliphatic hydrocarbon group, an alicyclic hydrocarbon group, an aromatic hydrocarbon group, a (meth)acryloyl group, a halogen-substituted, aliphatic hydrocarbon group, a halogen-substituted, alicyclic hydrocarbon group, or a halogen-substituted, aromatic hydrocarbon group, or a combination thereof.

The oligomer or polymer may include an amino group and may have an amine value of about 1 mg KOH/g to about 100 mg KOH/g.

A total amount of the carbon-based filler and the oligomer or polymer in the composite may be less than or equal to about 50 weight percent (wt %), based on a total weight of the composite.

The oligomer or polymer may be included in an amount of less than or equal to about 50 parts by weight per 100 parts by weight of the carbon-based filler.

The base polymer may include a liquid crystal polymer, and the carbon-based filler and the oligomer or polymer may be included in an amount of less than about 20 wt %, based on a total weight of the composite.

The base polymer may include a high density polyethylene (HDPE), and the carbon-based filler and the oligomer or polymer may be included in an amount of less than or equal to about 50 wt %, based on a total weight of the composite.

The composite may further include an inorganic moisture absorbent including a silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂, Ba(ClO₄)₂, Ca, or a combination thereof.

The inorganic moisture absorbent may be included in an amount of less than or equal to about 20 wt %, based on a total weight of the composite.

The composite may further include a crystal of the base polymer or a crystal of a polymer different than the base polymer, an inorganic material different from the inorganic moisture absorbent, a fiber-shaped material, or an additional moisture barrier material different from the carbon-based filler.

The additional moisture barrier material may include wollastonite, mica, an inorganic whisker, barium sulfate, kaolin, talc, nanoclay, a carbon fiber, a glass fiber, or a mixture thereof.

The battery case may further include a lid configured to cover at least a portion of the open side of the container and having at least one of a positive terminal and a negative terminal.

The container may include a plurality of cell compartments separated by at least one partition wall disposed in the space.

In another embodiment, a battery includes the battery case according to an embodiment and an electrode assembly including a positive electrode and a negative electrode housed in the container of the battery case.

The battery case according to an embodiment includes the composite including the base polymer, the carbon-based filler, and the oligomer or polymer that is dissolved in a solvent having a solubility parameter of about 15 MPa^{1/2} to about 30 MPa^{1/2}, the oligomer or the polymer having an amino group or a hydrophobic functional group. The battery case may be easily manufactured to have a desired shape and size with a low cost, and the manufactured battery case is light in weight, excellent in moisture transmission resistivity, mechanical properties, and heat dissipation properties. The battery case may advantageously be used to manufacture a battery or a battery module that protects the electrode assembly from moisture and includes at least one battery cell.

### BRIEF DESCRIPTION OF THE DRAWINGS

FIG. 1 is an exploded perspective view showing a battery case according to an embodiment.

FIG. 2 is an exploded perspective view showing a battery case according to another embodiment.

FIG. 3 is a schematic top view of a cross-section of an article prepared with a plate-like shaped filler having an aspect ratio of greater than 1 in the polymer matrix, and the arrow in the drawing shows an approximate path through which the moisture may pass through the article.

FIG. 4 is a cross-sectional SEM (scanning electron microscope) photograph of an article injection-molded with a mixture of a liquid crystal polymer and commercial graphite having an aspect ratio of about 1,000.

FIG. 5 is a cross-sectional SEM (scanning electron microscope) photograph of an article injection-molded with a mixture of the same liquid crystal polymer and the same graphite as in FIG. 4, and additionally together with a material having an affinity for the liquid crystal polymer and the graphite.

### DETAILED DESCRIPTION

Hereinafter, embodiments are described in detail. However, these embodiments are exemplary, and the present disclosure is not limited thereto. The invention may be embodied in many different forms, and the present disclosure is defined by the scope of claims. Unless defined otherwise, all terms (including technical and scientific terms) in the specification may be defined as commonly understood by one skilled in the art. The terms defined in a generally-used dictionary may not be interpreted ideally or exaggeratedly unless clearly defined.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

In the drawings, the thickness of each element is exaggerated for better comprehension and ease of description. Like reference numerals designate like elements throughout the specification. Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

It will be understood that when an element such as a layer, film, region, or plate is referred to as being “on” another element, it can be directly on the other element or intervening elements may also be present. In contrast, when an element is referred to as being “directly on” another element, there are no intervening elements present.

Recently, research on an electric vehicle (EV) using at least one battery system to supply a part or entire part of a motive power is actively being made. The electric vehicle exhibits greater fuel efficiency, e.g., a hybrid EV, and discharges lower emissions and less contamination to the environment compared to a traditional vehicle operated by an internal combustion engine Some electric vehicles using electricity use no gasoline at all or obtain entire motive power from electricity. As research on the electric vehicle continues forward, a requirement for an improved motive power source for the electric vehicle, for example, an improved battery module is of increasing interest.

A rechargeable lithium battery capable of being charged and discharged and having high energy density is a technical and commercial requirement of a battery for these electric vehicles. However, in a rechargeable lithium battery, when moisture is permeated through a battery exterior case, hydrofluoric acid (HF) is generated therein and causes performance degradation of an electrode. In order to prevent this performance degradation, an aluminum material having improved moisture transmission resistance is used as a case for a rechargeable lithium battery. For example, an electrode assembly including positive and negative electrodes is inserted into a case such as an aluminum pouch and then together into an aluminum can, and sealed to make a battery cell. A plurality of the battery cells is then used to form a battery module. However, this method requires a complicated assembly process, relatively high manufacture times, and high cost, and therefore, production efficiency needs to be improved. In other words, research is underway to realize a battery case and battery which may be manufactured by accommodating an electrode assembly in a cell-module integrated case, without constructing a separate battery cell after manufacturing the electrode assembly. In order to realize such a cell-module integrated structure, novel materials with a mechanical strength and moisture transmission resistivity are needed for the battery case for further improvement. This can present technical challenges as these novel materials for the battery case toned to be capable of efficiently discharging heat generated from the battery due to its long use, which is very important in terms of the stability of the battery.

A battery case formed of a conventional metal has a limited shape due to a limit in terms of a metal manufacture technology, a battery case having a desired shape and/or size requires a multistep process, a higher cost, and a high manufacture time. In addition, larger metal cases are heavy due to the weight of the metal and, when a plurality of containers are included in order to house a plurality of battery cells, the battery cases become heavier and even more expensive. Accordingly, there is a continuing need for an efficient battery case and battery module that can address the problems of heat management, moisture transmission, and the like, and being manufactured with a lower cost with improved mechanical properties, and being easily manufactured.

According to the above technical and commercial needs, there is an effort to develop a battery case using a polymer that may be easily manufactured in a desired form. However, polymers generally have a lower moisture transmission resistance, lower mechanical properties, and lower heat dissipation properties than a metal, and therefore, the development of such polymer battery cases is a technical challenge. Accordingly, there are demands for development of a polymer-based material that meet higher mechanical properties, moisture transmission resistance, and heat dissipation properties, and a battery case using the same.

Graphene is one of the materials with the highest hardness having an elastic modulus (Young's Modulus) of greater than or equal to 1 TeraPascals (TPa), which is one of the candidate materials that may be used as a reinforcement in high-performance composites. In addition to the graphene, carbon-based materials such as graphene-like materials, for example, graphite, graphite nanoplate, or carbon nanotubes may be used as reinforcement or reinforcing materials for various substrate materials due to their excellent mechanical properties and other excellent electrical and chemical properties. However, when these carbon-based materials are mixed with polymers, they are not uniformly dispersed in the polymers due to the non-affinity (incompatibility) with each other. Therefore, it is difficult to achieve the desired improvement of various physical properties simply by mixing the carbon-based material with a polymer.

There are attempts to improve tensile coefficients, strains, and heat dissipation properties of a composite made from a mixture of the carbon-based material and base materials such as polymer resins. However, there are very few attempts to implement heat dissipation properties and mechanical properties together with moisture transmission resistance of the composite simultaneously.

In developing a battery case using a polymer material, the inventors of the present disclosure have found that a composite made of the carbon-based material in the polymer not only improves mechanical properties, but also improves moisture transmission resistance and heat dissipation properties, and thus have tried to develop a battery case that may satisfy various properties required of a battery case.

As a result, the inventors have confirmed a battery case including a composite including a polymer, a carbon-based filler, and a material with affinity for both of the polymer and the carbon-based filler with significantly improved moisture transmission resistance, mechanical properties, and heat dissipation properties.

The battery case according to an embodiment includes a container configured to house an electrode assembly. The container includes a bottom wall and a plurality of side walls, and the bottom wall and the side walls are integrated to have an open side opposite the bottom wall and to provide a space for housing the electrode assembly. The container includes a composite of a base polymer, a carbon-based filler, and an oligomer or a polymer that is dissolved in a solvent having a solubility parameter of about 15 MPa^{1/2} to about 30 MPa^{1/2}, and the oligomer or the polymer has an amino group or a hydrophobic functional group. The battery case has a water vapor transmission rate (WVTR) of less than about 0.07 g/m²/day measured at a thickness of 1 mm, at 38° C. and relative humidity of 100% according to ISO 15106 or ASTM F1249.

As described above, in the battery case according to an embodiment, the container configured to house an electrode assembly includes a composite including a base polymer, a carbon-based filler, and a material having affinity for both the base polymer and the carbon-based filler, which is an oligomer or polymer that is dissolved in a solvent having a solubility parameter of about 15 MPa^{1/2} to about 30 MPa^{1/2} and has an amino group or a hydrophobic functional group. The oligomer or polymer that is dissolved in a solvent having a solubility parameter of about 15 MPa^{1/2} to about 30 MPa^{1/2} and has an amino group or a hydrophobic functional group is a material which may be dissolved in a solvent having the solubility parameter range. As a result, the oligomer or polymer may also be well mixed with the base polymer and the carbon-based filler under the presence of the solvent or even when the solvent is not present. Furthermore, as the oligomer or polymer includes an amino group or a hydrophobic functional group, it may be well adsorbed on the surface of the carbon-based filler.

Without being bound by a specific theory, the principle that the oligomer or polymer is adsorbed on the surface of the carbon-based filler is thought to be caused by a non-covalent bond with the carbon-based filler by nonpair electrons of a nitrogen atom of an amino group of the oligomer or polymer, or a Van der Waals bond caused by forming a hydrophobic block between a hydrophobic functional group of the oligomer or polymer and the carbon-based filler, or a pi (Π)-electron bond (stacking) caused by a physical adsorption, but is not limited thereto.

The oligomer or polymer may be bonded or adsorbed on the surface of the carbon-based filler by the various possible mechanisms, and thus the carbon-based filler may be well dispersed in the base polymer due to the surface bond or adsorption of the oligomer or polymer which is also well mixed with the base polymer. Like this, the carbon-based filler to which or on the surface of which the oligomer or polymer is bonded or adsorbed may be called, for the convenience, “surface-treated carbon-based filler.”

As will be described below, the carbon-based filler on which the oligomer or polymer is surface-treated may be preliminarily formed through a preliminary process of treating the surface of the carbon-based filler with the oligomer or polymer before forming the composite, or may be formed in-situ during the process of forming the composite by mixing the base polymer and the carbon-based filler together with the oligomer or polymer. In an exemplary embodiment, the oligomer or polymer may be preliminarily bonded to or absorbed on the surface of the carbon-based filler by mixing the same with the carbon-based filler before forming the composite.

On the other hand, when the oligomer or polymer includes an amino group, the oligomer or polymer may have an amine value of about 1 mg KOH/g to about 100 mg KOH/g. If the amine value that is an amount of the amino groups in the oligomer or polymer is within the range, the oligomer or polymer may easily adsorb or bind to the carbon-based filler.

In an embodiment, the amine value of the oligomer or polymer may be about 1 mg KOH/g to about 90 mg KOH/g, for example, about 2 mg KOH/g to about 90 mg KOH/g, for example, about 3 mg KOH/g to about 90 mg KOH/g, for example, about 2 mg KOH/g to about 85 mg KOH/g, for example, about 2 mg KOH/g to about 80 mg KOH/g, for example, about 2 mg KOH/g to about 75 mg KOH/g, for example, about 2 mg KOH/g to about 70 mg KOH/g, for example, about 3 mg KOH/g to about 85 mg KOH/g, for example, about 3 mg KOH/g to about 80 mg KOH/g, for example, about 3 mg KOH/g to about 75 mg KOH/g, for example, about 3 mg KOH/g to about 70 mg KOH/g, for example, about 3 mg KOH/g to about 65 mg KOH/g, for example, about 3 mg KOH/g to about 60 mg KOH/g, for example, about 4 mg KOH/g to about 80 mg KOH/g, for example, about 4 mg KOH/g to about 75 mg KOH/g, for example, about 4 mg KOH/g to about 70 mg KOH/g, for example, about 4 mg KOH/g to about 65 mg KOH/g, for example, about 4 mg KOH/g to about 60 mg KOH/g, for example, about 4 mg KOH/g to about 58 mg KOH/g, for example, or about 4 mg KOH/g to about 57 mg KOH/g, but is not limited thereto.

In an embodiment, the hydrophobic functional group may be any organic group having hydrophobicity, for example, an aliphatic hydrocarbon group, an alicyclic hydrocarbon group, an aromatic hydrocarbon group, a (meth)acryloyl group, a halogen-substituted aliphatic, a halogen-substituted alicyclic, or a halogen-substituted aromatic hydrocarbon group, or a combination thereof, for example, a group having at least one unsaturated bond in the molecule.

Examples of the hydrophobic functional group may include a linear or branched C1 to C30 alkyl group, a C3 to C30 cycloalkyl group, a C2 to C30 alkenyl group having at least one double bond, a C2 to C30 alkynyl group having at least one triple bond, a C6 to C30 aryl group, a C7 to C30 arylalkyl group, a C7 to C30 alkylaryl group, a C10 to C30 cycloalkyl aryl group, a (meth)acryloyl group, a fluorinated alkyl group, a fluorinated cycloalkyl group, a fluorinated aryl group, or a combination thereof, but are not limited thereto.

In an embodiment, the base polymer may include polycarbonate, polyolefin, polyvinyl, polyamide, polyester, polyphenylene sulfide (PPS), polyphenylene ether, polyphenylene oxide, polystyrene, polyamide, a polycyclic olefin copolymer, an acrylonitrile-butadiene-styrene copolymer, a liquid crystal polymer (LCP), a mixture thereof, an alloy thereof, or a copolymer thereof.

The carbon-based filler may include graphite, graphene, graphite nanoplate, or a combination thereof, and may have a plate-like shape, for example, having a high aspect ratio in terms of interfering with a movement path of moisture within the composite. For example, the carbon-based filler may have an aspect ratio, that is, a ratio of the longest diameter relative to the shortest diameter of greater than or equal to about 10, for example, greater than or equal to about 20, greater than or equal to about 30, greater than or equal to about 40, greater than or equal to about 50, greater than or equal to about 60, greater than or equal to about 70, greater than or equal to about 80, greater than or equal to about 90, greater than or equal to about 100, greater than or equal to about 120, greater than or equal to about 150, greater than or equal to about 180, greater than or equal to about 200, greater than or equal to about 250, greater than or equal to about 300, greater than or equal to about 350, greater than or equal to about 400, greater than or equal to about 450, greater than or equal to about 500, greater than or equal to about 600, greater than or equal to about 700, greater than or equal to about 800, greater than or equal to about 900, or greater than or equal to about 1,000, but it is not limited thereto.

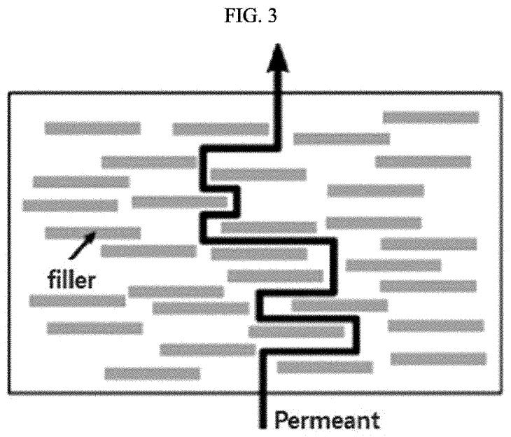

During our development of a composite including the base polymer and the carbon-based filler, we found that not only the mechanical properties are enhanced, but also the moisture transmission resistance and heat dissipation properties are increased. We estimate that because the carbon-based filler is uniformly dispersed in the base polymer, and also the bond at the interface between the carbon-based filler and the base polymer is excellent, voids in the composite are decreased. Furthermore, when the carbon-based filler is a plate-like shape having a high aspect ratio, the carbon-based filler may act as an obstacle to a path of moisture passing the composite, and the moving path of moisture in the composite is extended, so that the moisture transmission resistance of the battery case including the composite may further increase. This moisture transmission resistance is schematically represented and illustrated in FIG. 3.

Meanwhile, as described above, in the composite, the bonding at the interface between the base polymer and the carbon-based filler is enhanced by the oligomer or the polymer having the affinity for both materials. We believe the observed affinity or compatibility is in-part due to a decrease in void space in the composite, and as a result, the problems of delaminating or scattering of the carbon-based filler from the composite do not occur after preparing the composite. This result is clearly observed in a comparison of the SEM (Scanning Electron Microscopy) images of the cross-sectional surfaces of the composites according to the Examples and the Comparative Examples.

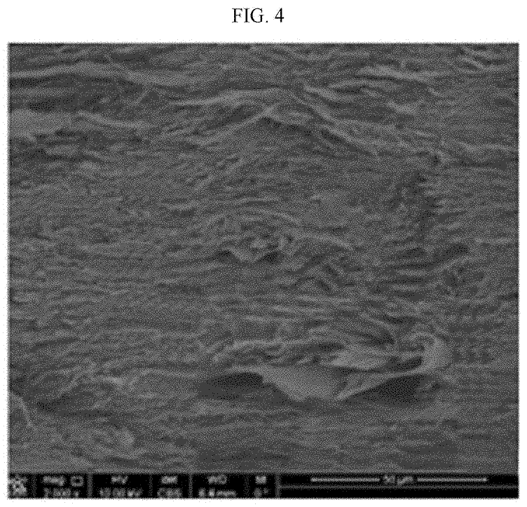

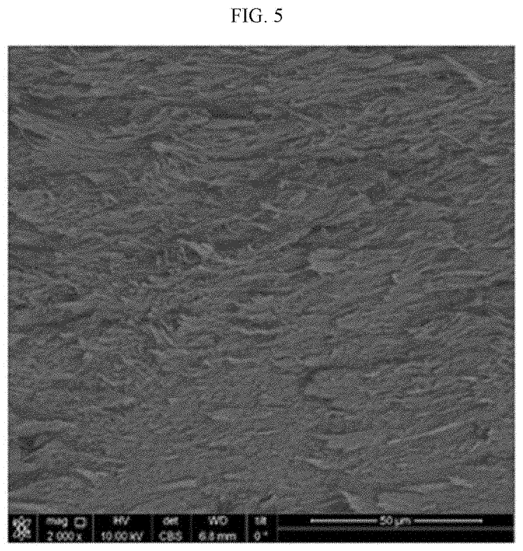

FIG. 5 is an SEM image showing a cross-sectional surface of the molded article obtained from a composite including a base polymer, a carbon-based filler, and an oligomer or polymer having an affinity for both the base polymer and the carbon-based filler; and FIG. 4 is an SEM image showing a cross-sectional surface of the molded article obtained from a composite including the same base polymer and the same carbon-based filler as those of FIG. 5, but in the absence of the oligomer or polymer having affinity for both the base polymer and the carbon-based filler.

FIG. 5 shows that the cross-sectional surface is generally uniform, and a size and a frequency of the void space is very small; but FIG. 4 shows that the cross-sectional surface is generally uneven, and a lot of irregular and large void spaces are found on the cross-sectional surface. In the composite according to the Comparative Example where only the base polymer and the carbon-based filler are mixed in the absence of an oligomer or polymer having good affinity for both the base polymer and the carbon-based filler, the carbon-based filler may not uniformly disperse in the base polymer, but instead, agglomerate or the bonding at the interface between the base polymer and the carbon-based filler is unfavorable so the cross-sectional surface of the composite is not uniform, and the void space or the area where the carbon-based fillers agglomerate is large and present. As a result, the carbon-based filler may delaminate from the composite, and the mechanical properties of the composite may further deteriorate. In addition, if the bonding at the interface between the base polymer and the carbon-based filler is unfavorable leading to an increase is size of void spaces, the moisture transmission resistance and the heat dissipation properties may be also deteriorate or decrease.

The size of the carbon-based filler is not particularly limited, but the longest diameter may be about 1 micrometer (μm) to about 100 μm, for example, about 5 μm to about 100 μm, about 10 μm to about 100 μm, about 15 μm to about 100 μm, about 20 μm to about 100 μm, about 25 μm to about 100 μm, or about 30 μm to about 100 μm, considering the carbon-based filler as an obstacle to the moisture movement, but is not limited thereto.

A total amount of the carbon-based filler and the oligomer or polymer that is dissolved in a solvent having a solubility parameter of about 15 MPa^{1/2} to about 30 MPa^{1/2} and has an amino group or a hydrophobic functional group may be less than or equal to about 50 wt % based on a total weight of the composite. For example, a total amount of the carbon-based filler and the oligomer or polymer may be less than or equal to about 45 wt %, for example less than or equal to about 40 wt %, less than or equal to about 35 wt %, less than or equal to about 30 wt %, less than or equal to about 25 wt %, less than or equal to about 20 wt %, less than or equal to about 15 wt %, less than or equal to about 13 wt %, less than or equal to about 10 wt %, less than or equal to about 7 wt %. For example, an amount of the carbon-based filler and the oligomer or polymer that is dissolved in a solvent having a solubility parameter of about 15 MPa^{1/2} to about 30 MPa^{1/2} and has an amino group or a hydrophobic functional group may be greater than or equal to about 1 wt % and less than or equal to about 50 wt %, greater than or equal to about 2 wt % and less than or equal to about 50 wt %, greater than or equal to about 3 wt % and less than or equal to about 50 wt %, greater than or equal to about 5 wt % and less than or equal to about 45 wt %, greater than or equal to about 5 wt % and less than or equal to about 40 wt %, greater than or equal to about 5 wt % and less than or equal to about 35 wt %, greater than or equal to about 5 wt % and less than or equal to about 30 wt %, greater than or equal to about 5 wt % and less than or equal to about 25 wt %, greater than or equal to about 5 wt % and less than or equal to about 20 wt %, greater than or equal to about 5 wt % and less than or equal to about 15 wt %, or greater than or equal to about 5 wt % and less than or equal to about 10 wt %, based on a total weight of the composite, but is not limited thereto.

The oligomer or polymer that is dissolved in a solvent having a solubility parameter of about 15 MPa^{1/2} to about 30 MPa^{1/2} and has an amino group or a hydrophobic functional group may be included in an amount of less than or equal to about 50 parts by weight per 100 parts by weight of the carbon-based filler. For example, the oligomer or polymer may be included in an amount of less than or equal to about 45 parts by weight per 100 parts by weight of the carbon-based filler, for example, less than or equal to about 35 parts by weight per 100 parts by weight of the carbon-based filler, less than or equal to about 45 parts by weight per 100 parts by weight of the carbon-based filler, about 10 parts by weight to about 50 parts by weight per 100 parts by weight of the carbon-based filler, about 15 parts by weight to about 50 parts by weight per 100 parts by weight of the carbon-based filler, about 20 parts by weight to about 50 parts by weight per 100 parts by weight of the carbon-based filler, about 25 parts by weight to about 50 parts by weight per 100 parts by weight of the carbon-based filler, about 25 parts by weight to about 45 parts by weight per 100 parts by weight of the carbon-based filler, about 25 parts by weight to about 40 parts by weight per 100 parts by weight of the carbon-based filler, about 25 parts by weight to about 35 parts by weight per 100 parts by weight of the carbon-based filler, or about 25 parts by weight to about 30 parts by weight per 100 parts by weight of the carbon-based filler, but it is not limited thereto.

In an exemplary embodiment, the base polymer may include a liquid crystal polymer or a high density polyethylene (HDPE).

The liquid crystal polymer includes an aromatic polyester that is known as an engineering plastic having a relatively high heat resistance and mechanical properties, and a relatively high moisture transmission resistance. However, the requirements of high mechanical properties and moisture transmission resistance for the battery case may not be satisfied with merely the conventional liquid crystal polymer. Accordingly, in an embodiment, a composite including the carbon-based filler and the oligomer or the polymer having affinity for both of the carbon-based filler and the liquid crystal polymer in addition to the liquid crystal polymer is provided, so as to provide a battery case with much higher mechanical properties and moisture transmission resistance.

In an embodiment, the liquid crystal polymer may include a liquid crystal aromatic polyester, and the liquid crystal aromatic polyester may include a structural unit represented by Chemical Formula 1; a structural unit represented by Chemical Formula 2 and a structural unit represented by Chemical Formula 3; or a structural unit represented by Chemical Formula 1, a structural unit represented by Chemical Formula 2, and a structural unit represented by Chemical Formula 3:

*-(—(C═O)—Ar¹—O—)-* Chemical Formula 1

*-(—(C═O)—Ar²—(C═O)—)-* Chemical Formula 2

*-(—O—Ar³—O—)-* Chemical Formula 3

In Chemical Formulae 1 to 3,

Ar¹, Ar², and Ar³ are each independently a group including a substituted or unsubstituted C6 to C30 aromatic ring group, for example, a substituted or unsubstituted C6 to C30 sing aromatic ring group, a condensed ring of two or more substituted or unsubstituted C6 to C30 aromatic ring groups, or a group including two or more substituted or unsubstituted C6 to C30 aromatic ring groups that are linked by a single bond, —O—, —C(═O)—, —C(OH)₂—, —S—, or —S(O)₂—.

For example, Ar¹, Ar², and Ar³ of Chemical Formulae 1 to 3 may each independently be a substituted or unsubstituted phenylene group, biphenylene group, naphthylene group, anthracenyl group, phenanthracenyl group, naphthacenyl group, or pyrenylene group, and the like, for example, a phenylene group, a biphenylene group, or a naphthylene group, but are not limited thereto.

The structural unit represented by Chemical Formula 1 may be derived from an aromatic hydroxycarboxylic acid, and the aromatic hydroxycarboxylic acid may be at least one of 4-hydroxybenzoic acid, glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2,5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, or p-β-hydroxyethoxybenzoic acid, for example, 4-hydroxybenzoic acid and/or 6-hydroxy-2-naphthoic acid, but is not limited thereto.

The structural unit represented by Chemical Formula 2 may be derived from an aromatic dicarboxylic acid, and the aromatic dicarboxylic acid may be at least one of terephthalic acid, 4,4′-biphenyldicarboxylic acid, 4,4′-terphenyldicarboxylic acid, 1,6-naphthalene dicarboxylic acid, 2,6-naphthalene dicarboxylic acid, 1,4-naphthalene dicarboxylic acid, 2,7-naphthalene dicarboxylic acid, diphenyl ether-4,4′-dicarboxylic acid, diphenoxyethane-4,4′-dicarboxylic acid, diphenoxy butane-4,4′-dicarboxylic acid, diphenyl ethane-4,4′-dicarboxylic acid, isophthalic acid, diphenyl ether-3,3′-dicarboxylic acid, diphenoxyethane-3,3′-dicarboxylic acid, diphenyl ethane-3,3′-dicarboxylic acid, chloro terephthalic acid, dichloroterephthalic acid, dichloroisophthalic acid, bromo terephthalic acid, methylterephthalic acid, dimethylterephthalic acid, ethyl terephthalic acid, methoxy terephthalic acid, or ethoxyterephthalic acid, for example, terephthalic acid, isophthalic acid, naphthalene dicarboxylic acid, or a combination thereof, but is not limited thereto.

The structural unit represented by Chemical Formula 3 may be derived from an aromatic diol, and the aromatic diol may be at least one of catechol, resorcinol, hydroquinone, 4,4′-dihydroxybiphenyl, 2,2-bis(4′β-hydroxyethoxyphenyl) propane, bis(4-hydroxyphenyl) sulfone, bis(4-β-hydroxyethoxyphenyl) sulfonic acid, 9,9′-bis(4-hydroxyphenyl) fluorene, 3,3′-dihydroxybiphenyl, 4,4′-dihydroxyterphenyl, 2,6-naphthalenediol, 4,4′-dihydroxydiphenyl ether, bis(4-hydroxyphenoxy) ethane, 3,3′-dihydroxydiphenyl ether, 1,6-naphthalenediol, 2,2-bis(4-hydroxyphenyl) propane, bis(4-hydroxyphenyl) methane, chloro hydroquinone, methylhydroquinone, tert-butyl hydroquinone, phenyl hydroquinone, methoxy hydroquinone, phenoxyhydroquinone, 4-chloro resorcinol, or 4-methyl resorcinol, for example, hydroquinone, 4,4′-dihydroxybiphenyl, or a combination thereof, but is not limited thereto.

In an embodiment, the liquid crystal aromatic polymer may include a liquid crystal aromatic polyamide, and the liquid crystal aromatic polyamide may include a structural unit represented by Chemical Formula 4; a structural unit represented by Chemical Formula 5 and the structural unit represented by Chemical Formula 2; or a structural unit represented by Chemical Formula 4, a structural unit represented by Chemical Formula 5, and a structural unit represented by Chemical Formula 2:

*-(—(C═O)—Ar⁴—NH—)-* Chemical Formula 4

*-(—NH—Ar⁴—NH—)-* Chemical Formula 5

*-(—(C═O)—Ar²—(C═O)—)-* Chemical Formula 2

In Chemical Formula 4, Chemical Formula 5, and Chemical Formula 2,

Ar⁴, Ar⁵, and Ar² are each independently a group including a substituted or unsubstituted C6 to C30 aromatic cyclic group, for example a substituted or unsubstituted C6 to C30 single aromatic ring group, a condensed ring of two or more substituted or unsubstituted C6 to C30 aromatic cyclic groups, or a group including two or more substituted or unsubstituted C6 to C30 aromatic cyclic groups that are linked by a single bond, —O—, —C(═O)—, —C(OH)₂—, —S—, or —S(O)₂—.

For example, Ar⁴, Ar⁵, and Ar² of Chemical Formula 4, Chemical Formula 5, and Chemical Formula 2 may each independently be a phenylene group, biphenylene group, a naphthalenylene group, an anthracenylene group, phenanthrenylene group, a naphthacenylene group, or a pyrenylene group, and the like, for example, a phenylene group, a biphenylene group, or a naphthalenylene group, but are not limited thereto.

The structural unit represented by Chemical Formula 4 may be derived from an aromatic amino carboxylic acid, and the aromatic aminocarboxylic acid may be for example, 4-aminobenzoic acid, 2-amino-naphthalene-6-carboxylic acid, 4-aminobiphenyl-4-carboxylic acid, or a combination thereof, but is not limited thereto.

The structural unit represented by Chemical Formula 5 may be derived from an aromatic diamine, and the aromatic diamine may be at least one of 1,4-phenylene diamine, 1,3-phenylene diamine, 2,6-naphthalene diamine, N,N,N′,N′-tetramethyl-1,4-diaminobenzene, N,N,N′,N′-tetramethyl-1,3-diaminobenzene, 1,8-bis(dimethylamino)naphthalene, or 4,5-bis(dimethylamino) fluorene, for example, 1,4-phenylene diamine, 1,3-phenylene diamine, 2,6-naphthalene diamine, or a combination thereof, but is not limited thereto.

The structural unit represented by Chemical Formula 2 may be derived from the above-described aromatic dicarboxylic acid, and the aromatic dicarboxylic acid may be, for example, terephthalic acid, isophthalic acid, naphthalene dicarboxylic acid, or a combination thereof.

In an embodiment, the liquid crystal polymer 1 may include a liquid crystal aromatic polyester including (1) a structural unit represented by Chemical Formula 6, and/or (2) at least one of a structural unit represented by Chemical Formula 7, a structural unit represented by Chemical Formula 8, and a structural unit represented by Chemical Formula 9:

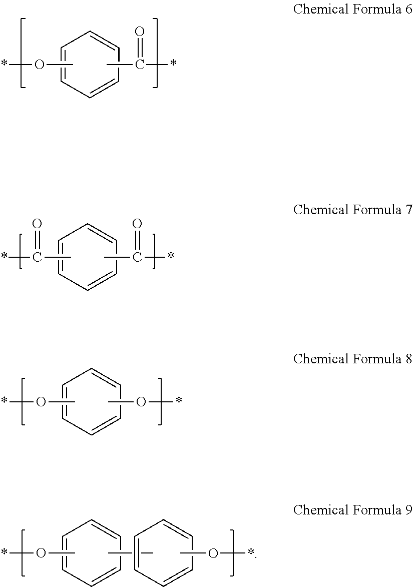

In an embodiment, the structural unit represented by Chemical Formula 6 may be derived from p-hydroxybenzoic acid (HBA), the structural unit represented by Chemical Formula 7 may be derived from isophthalic acid (IPA) and/or terephthalic acid (TPA), the structural unit represented by Chemical Formula 8 may be derived from hydroquinone (HQ), and the structural unit represented by Chemical Formula 9 may be derived from 4.4′-biphenol (BP).

If the composite includes the liquid crystal polymer as the base polymer, the carbon-based filler and the oligomer or polymer that is dissolved in a solvent having a solubility parameter of about 15 MPa^{1/2} to about 30 MPa^{1/2} and has an amino group or a hydrophobic functional group may be included in an amount of less than or equal to about 20 wt %, less than or equal to about 18 wt %, less than or equal to about 15 wt %, less than or equal to about 13 wt %, or less than or equal to about 10 wt %. For example, the composite that includes the liquid crystal polymer as the base polymer, the carbon-based filler and the oligomer or polymer that is dissolved in a solvent having a solubility parameter of about 15 MPa^{1/2} to about 30 MPa^{1/2} and has an amino group or a hydrophobic functional group may be included in an amount of about 1 wt % to about 20 wt %, about 3 wt % to about 15 wt %, about 3 wt % to about 10 wt %, or about 5 wt % to about 10 wt %, based on a total weight of the composite.

In another embodiment, when the composite includes a high density polyethylene as the base polymer, the carbon-based filler and the oligomer or the polymer that is dissolved in a solvent having a solubility parameter of about 15 MPa^{1/2} to about 30 MPa^{1/2} and has an amino group or a hydrophobic functional group may be included in an amount of less than or equal to about 50 wt % based on a total weight of the composite.

The high density polyethylene (HDPE) is a polyethylene having a density of about 930 kg/m³ to about 970 kg/m³, and having little branch, and therefore having stronger intermolecular forces and tensile strengths than a low density polyethylene (LDPE). However, a high density polyethylene generally has a slightly lower moisture transmission resistance than the liquid crystal polymer. Therefore, if the high density polyethylene is included as a base polymer, the carbon-based filler and the oligomer or polymer having an affinity for the carbon-based filler and the high density polyethylene may be included in a higher amount than when a liquid crystal polymer is used as a base polymer, in order to achieve a moisture transmission resistance required for a battery case.

For example, when the composite includes the high density polyethylene as a base polymer, the carbon-based filler and the oligomer or the polymer that is dissolved in a solvent having a solubility parameter of about 15 MPa^{1/2} to about 30 MPa^{1/2} and has an amino group or a hydrophobic functional group may be included in an amount of less than or equal to about 50 wt %, for example less than or equal to about 45 wt %, less than or equal to about 40 wt %, less than or equal to about 35 wt %, less than or equal to about 30 wt %, less than or equal to about 25 wt %, less than or equal to about 20 wt %, for example, about 10 wt % to about 50 wt %, about 10 wt % to about 45 wt %, about 15 wt % to about 45 wt %, about 15 wt % to about 40 wt %, about 15 wt % to about 35 wt %, about 15 wt % to about 30 wt %, about 15 wt % to about 25 wt %, or about 15 wt % to about 20 wt % based on a total weight of the composite.

In an embodiment, the composite may further include at least one inorganic moisture absorbent such as a silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂, Ba(ClO₄)₂, or Ca.

As the battery case according to an embodiment includes a composite including a base polymer, the carbon-based filler, and an oligomer or polymer having affinity for both the base polymer and the carbon-based filler, the moisture transmission resistance, the mechanical properties, and the heat dissipation properties and the like may be further enhanced compared to the battery case composed of only the base polymer, and by further adding the materials known as an absorbent for improving the moisture transmission resistance, for example, a physical absorbent or a chemical absorbent component thereto, the moisture transmission resistance of the battery case may be more enhanced. The inorganic moisture absorbent may be included in an amount of less than or equal to about 20 wt %, for example less than or equal to about 18 wt %, less than or equal to about 15 wt %, less than or equal to about 1 wt % to about 20 wt %, about 1 wt % to about 18 wt %, about 1 wt % to about 15 wt %, about 2 wt % to about 18 wt %, about 2 wt % to about 15 wt %, about 3 wt % to about 15 wt %, about 3 wt % to about 10 wt %, about 3 wt % to about 8 wt %, about 5 wt % to about 5 wt %, about 5 wt % to about 10 wt %, or about 5 wt % to about 8 wt % based on a total weight of the composite, but is not limited thereto.

In an exemplary embodiment, the inorganic moisture absorbent may include zeolite as a physical adsorbent, CaO or MgO as a chemical adsorbent, or a combination thereof, but is not limited thereto.

If the inorganic moisture absorbent is CaO, a particle size of CaO may be about 0.1 μm to about 1 μm, for example, about 0.1 μm to about 0.9 μm, about 0.1 μm to about 0.8 μm, about 0.1 μm to about 0.7 μm, about 0.1 μm to about 0.6 μm, about 0.1 μm to about 0.5 μm, about 0.1 μm to about 0.4 μm, about 0.2 μm to about 0.5 μm, or about 0.2 μm to about 0.4 μm.

Zeolite is a physical moisture absorbent absorbing water through a particle having a pore, while CaO is a chemical water adsorbent adsorbing water through a chemical reaction with a water molecule. Accordingly, in an embodiment, a water vapor transmission rate of the battery case fabricated therefrom may be further reduced by including both zeolite and CaO as an inorganic moisture absorbent.

The composite may further include a known moisture barrier material in addition to the carbon-based filler. Such a moisture barrier material may further include, for example, a crystal of the base polymer, or a crystal of a different polymer from the base polymer, a particle of an inorganic material different from the inorganic moisture absorbent, or a fiber-shaped material, such as a glass fiber or a carbon fiber. Specific examples of the moisture barrier material may include wollastonite, mica, an inorganic whisker, such as, for example, a mineral whisker, a metal whisker, and the like, barium sulfate, kaolin, talc, nanoclay, a carbon fiber or a glass fiber having an aspect ratio of greater than or equal to about 100, or a mixture thereof, but are not limited thereto.

The battery case, or composite described herein, according to an embodiment may have a water vapor transmittance rate of less than about 0.07 g/m²/day. Moreover, moisture transmission resistance may be further improved by adjusting types and amounts of the base polymer, types and amounts of the carbon-based filler, types and amounts of the oligomer or the polymer that is dissolved in a solvent having a solubility parameter of about 15 MPa^{1/2} to about 30 MPa^{1/2} and has an amino group or a hydrophobic functional group, inclusion and amounts of the inorganic moisture absorbent, types of the inorganic moisture absorbent, and types and amounts of the additional moisture barrier material. For example, the moisture transmission resistance of a liquid crystal polymers is generally superior to the moisture transmission resistance of a high density polyethylene, and therefore, as described above, if a liquid crystal polymer is used as the base polymer, the amount of the carbon-based filler may be used in a less amount than when using a high density polyethylene as the base polymer. Also, if the same base polymer is used, the moisture transmission resistance tends to increase as the amount of the carbon-based filler increases. When including an inorganic moisture absorbent to improve the moisture transmission resistance of the base polymer, the moisture transmission resistance is improved according to increasing the amount of the inorganic moisture absorbent, but generally, one observes an unfavorable decrease in the impact strength. The battery case according to an embodiment has an amazing unexpected effect on enhancing the moisture transmission resistance and also on increasing the impact strength and the heat dissipation properties. This is because at least a portion of the surface of the carbon-based filler is capped by the oligomer or polymer having affinity for both the base polymer and the carbon-based filler such that it can be more uniformly mixed with the base polymer, and can be closely bonded with minimal or at least smaller voids at the interface with the base polymer, as described above.

The battery case according to an embodiment may further improve moisture transmission resistance according to types and amounts of the base polymer, types and amounts of the carbon-based filler, inclusion and amounts of the inorganic moisture absorbent. The battery case, or the composite, according to an embodiment may have, for example, a very low water vapor transmittance rate of less than or equal to about 0.065 g/m²/day, less than or equal to about 0.060 g/m²/day, less than or equal to about 0.055 g/m²/day, less than or equal to about 0.050 g/m²/day, less than or equal to about 0.045 g/m²/day, less than or equal to about 0.040 g/m²/day, less than or equal to about 0.035 g/m²/day, less than or equal to about 0.030 g/m²/day, less than or equal to about 0.025 g/m²/day, less than or equal to about 0.020 g/m²/day, less than or equal to about 0.015 g/m²/day, less than or equal to about 0.014 g/m²/day, less than or equal to about 0.013 g/m²/day, less than or equal to about 0.012 g/m²/day, less than or equal to about 0.011 g/m²/day, or less than or equal to about 0.010 g/m²/day, but is not limited thereto.

Meanwhile, as understood from the Example and Comparative Examples, in the battery case, or the composite described, according to an embodiment, the impact strength and the heat dissipation properties are also enhanced, compared to the case or composite that does not include the carbon-based filler or the case of not including the oligomer or polymer having good affinity for both the carbon-based filler and the base polymer even if including the carbon-based filler. In addition, as in the inorganic moisture absorbent, if only the carbon-based filler is mixed with the base polymer to form a composite without including the oligomer or polymer having good affinity for both the carbon-based filler and the base polymer, the battery case or composite including the same shows even lower impact strength than the battery case or composite including only the base polymer. Therefore, by including the oligomer or polymer having affinity for both the base polymer and the carbon-based filler, the battery case including the resultant composite has significantly enhanced moisture transmission resistance, mechanical properties, and heat dissipation properties or the like, which are unexpected and significant effects.

As described above, since the container of the battery case according to an embodiment includes the composite including the base polymer, the carbon-based filler, and the oligomer or polymer having affinity for both the base polymer and the carbon-based filler, it may have the aforementioned moisture transmission resistance. Thus, it may have moisture transmission resistance as much as that of the conventional metal pouch exterior material surrounding an electrode assembly for a rechargeable lithium battery assembly. As the container includes space housing an electrode assembly including a positive electrode and a negative electrode and has the aforementioned moisture transmission resistance, an additional exterior material such as a metal pouch and the like surrounding the electrode assembly is not needed, so it may be directly introduced into the battery container to provide a battery.

In addition, according to an embodiment, the battery container may include a plurality of cell compartments separated by at least one partition wall disposed in the space. Thus, even in the case of a battery module including a plurality of battery cells, by introducing each electrode assembly into each cell compartment in the battery container without the needs to surround each electrode assembly with a metal pouch or the like, it may simply provide a battery module including a plurality of battery cells. In other words, the battery case according to an embodiment may be a cell-module integrated battery case.

Conventionally, an electrode assembly including positive and negative electrodes is formed, and then, wrapped with a metal pouch having moisture transmission resistance to form a battery cell, and then, packed in a metallic battery case to manufacture a battery module, which is complicated in terms of a process, takes a long time, and costs increasingly high.

As described above, the battery case according to an embodiment may be easily fabricated in a cell-module integrated battery case, so it may have effects on significantly saving the time and the cost, compared to the conventional case of using the metal battery case in terms of the cost and the time on fabricating the same. As well, the battery case according to an embodiment includes a polymer material as a main component, so that it is light in a weight and free-shape and may be formed in a low cost.

As the container of the battery case according to an embodiment has the aforementioned water vapor transmission rate, an electrode assembly including negative and positive electrodes is not fabricated into a unit cell by using an additional metal pouch and the like but into a battery by being directly housed in the container of the battery case according to an embodiment and injecting an electrolyte thereinto.

The battery case may be a battery case for a rechargeable lithium battery, but is not limited thereto, and may be a case for a battery housing a plurality of electrode assemblies and requiring high moisture transmission resistance and mechanical properties.

The battery case may further include for example a lid configured to cover at least a portion of the open side of the container and having at least one of a positive terminal and a negative terminal. The lid may have at least one of a positive terminal and a negative electrode terminal, for example, both of the positive terminal and the negative electrode terminal. The lid may include the same composite as the container, or the lid may include a different material from the container.

On the other hand, the battery case according to an embodiment may be manufactured by molding the composite including the base polymer, the carbon-based filler, and the oligomer or polymer having an affinity for both of the base polymer and the carbon-based filler. The composite including the base polymer and the carbon-based filler and the oligomer or polymer having an affinity for both of the base polymer and the carbon-based filler may be molded according to the various molding methods known in the fields pertained to the art, for example, extrusion molding, injection molding, blow molding, press molding, and the like, so as to provide a battery case according to an embodiment.

In an embodiment, the composite may be obtained by a one-pot method of inputting all of the base polymer, the carbon-based filler, and the oligomer or polymer having an affinity for both of the base polymer and the carbon-based filler into one extruder from the beginning; and extruding the same while melt blending at a high temperature. The obtained composite may be cut by a pelletizer or the like to provide a composite pellet. The composite pellet may be formed to a battery case having a desirable shape and size through the various known molding methods.

Instead of a method of inputting a base polymer and a carbon-based filler and an oligomer or polymer having an affinity for both of the base polymer and the carbon-based filler into one extruder and melt-blending the same from the beginning, according to another embodiment, for preparing the composite, the carbon-based filler is preliminarily surface-treated with the oligomer or polymer to provide a surface-treated carbon-based filler that at least a portion of the surface is treated with the oligomer or polymer, and the obtained surface-treated carbon-based filler is mixed with the base polymer and then extruded to provide a composite. For example, the carbon-based filler and the oligomer or polymer are dispersed together in a dispersing agent and aged for a predetermined time, so that the oligomer or polymer is adsorbed or bonded on the surface of the carbon-based filler, and then it is washed, filtered, and dried to provide a carbon-based filler in which the surface is treated with the oligomer or polymer. The obtained surface-treated carbon-based filler is mixed with the base polymer, and then the mixture is introduced into a twin-screw extruder through a hopper and melt-extruded at about 300° C. and 30 rpm and then cut by a pelletizer to provide a composite pellet.

Hereinafter, a battery case according to an embodiment is described with reference to the appended drawings.

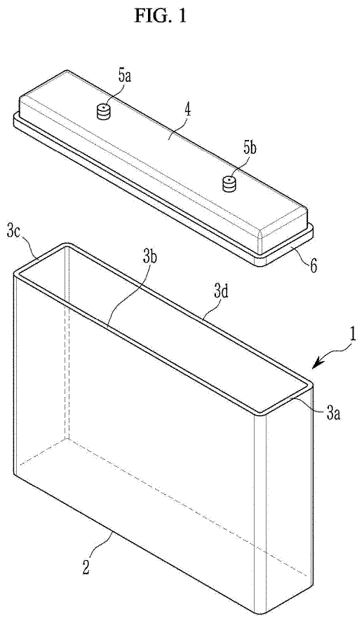

FIG. 1 is an exploded perspective view of a battery case according to an embodiment.

Referring to FIG. 1, a battery case according to an embodiment includes a container 1 including a bottom wall 2 and a plurality of (e.g., 3, 4, or greater) side walls 3a, 3b, 3c, and 3d that are integrated to provide a space for housing an electrode assembly. The container 1 has an open side opposite the bottom wall 2 and an electrode assembly may be housed in the container 1 through the open side 2.

Herein, “integrated” indicates a state that the bottom wall is connected to the plurality of side walls, and thus all the other sides except for the open side provide a closed and sealed space. A method for this integration is not particularly limited but may include, for example, as described above, a method of preparing a composite from a base polymer, a carbon-based filler, and an organic compound having affinity for the base polymer and the carbon-based filler, and molding the composite to integrate the bottom wall and the plurality of side walls and to provide a container having a space for housing electrodes, or a method of separately molding the bottom wall and the plurality of side walls and then, connecting them in a publicly known method such as welding, boning, or the like. As described above, the method for integration is not limited to a particular method but may include various methods known to those who have ordinary skill in the art, through which a container of a battery case is fabricated to have a space for housing an electrode assembly by integrating the bottom wall and the plurality of side walls.

The battery case may further include a lid 4 to close (e.g., seal) at least one part, for example, a whole part of the open side of the container 1. The lid 4 may have at least one of the positive terminal 5a and the negative terminal 5b (e.g., positive terminal and negative terminal). The lid 4 may include the same material as the container 1 or a different material from the container 1 and the battery case according to an embodiment may be entirely sealed by covering the open side of the container 1 with the lid 4 and sealing the same.

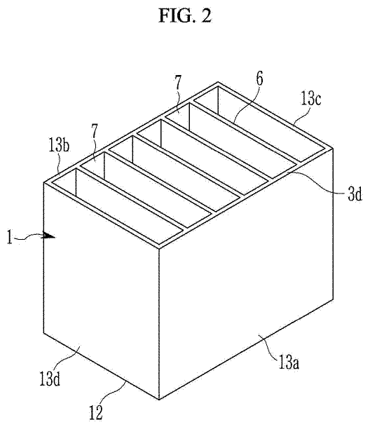

FIG. 2 is an exploded perspective view of a battery case according to another embodiment.

Referring to FIG. 2, a container 1 of a battery case according to an embodiment has a space formed by integrating a bottom wall 12 with a plurality of side walls (e.g., 3, 4, or more) 13a, 13b, 13c, and 13d and an open side opposite the bottom wall 12, and in the space, at least one partition wall 6 (e.g., 2, 3, 4, 5, or more) is provided. Accordingly, the container may include a plurality of (e.g., greater than or equal to 2, for example, greater than or equal to 3, greater than or equal to 4, or greater than or equal to 5) cell compartments 7 by the partition wall 6. Each battery cell compartment 7 may include the electrode assembly that will be described later, and a battery module may be fabricated by housing at least two electrode assemblies in each battery cell compartment and injecting an electrolyte solution therein. After disposing the electrode assembly and injecting the electrolyte solution, the open side of the container 1 may be closed or sealed with a lid, which is not shown.

FIGS. 1 and 2 show the container 1 of the battery case having a rectangular parallelepiped, but the battery case according to an embodiment has no limit to the shape but may have various shapes and sizes.

Another embodiment provides a battery including the battery case according to the embodiment and an electrode assembly housed in the container of the battery case and including a positive electrode and a negative electrode. Details for the battery case are the same as described above.

The electrode assembly includes a positive electrode, a negative electrode, and a separator disposed therebetween. The electrode assembly may further include, for example an aqueous non-aqueous electrolyte solution in the separator. The types of the electrode assembly are not particularly limited. In an embodiment, the electrode assembly may include an electrode assembly for a rechargeable lithium battery. The positive electrode, the negative electrode, the separator, and the electrolyte solution of the electrode assembly may be desirably selected according to types of the electrode and are not particularly limited. Hereinafter, the electrode assembly for a rechargeable lithium battery is exemplified but the present disclosure is not limited thereto.

The positive electrode may include, for example, a positive active material disposed on a positive current collector and may further include at least one of a conductive material and a binder. The positive electrode may further include a filler. The negative electrode may include, for example a negative active material disposed on a negative current collector and may further include at least one of a conductive material and a binder. The negative electrode may further include a filler.

The positive active material may include, for example a (solid solution) oxide including lithium but is not particularly limited as long as it is a material capable of intercalating and de-intercalating lithium ions electrochemically. The positive active material may be a layered compound such as lithium cobalt oxide (LiCoO₂), lithium nickel oxide (LiNiO₂), and the like, a compound substituted with one or more transition metal; a lithium manganese oxide such as chemical formula Li₁₊ₓMn₂₋ₓO₄ (wherein, x is 0 to 0.33), LiMnO₃, LiMn₂O₃, LiMnO₂, and the like; lithium copper oxide (Li₂CuO₂), vanadium oxide such as LiV₃O₈, LiFe₃O₄, V₂O₅, Cu₂V₂O₇, and the like; a Ni site-type lithium nickel oxide represented by chemical formula LiNi₁₋ₓMxO₂ (wherein, M=Co, Mn, Al, Cu, Fe, Mg, B, or Ga and x=0.01 to 0.3); a lithium manganese composite oxide represented by chemical formula LiMn₂₋ₓMₓO₂ (wherein, M=Co, Ni, Fe, Cr, Zn, or Ta and x=0.01 to 0.1) or Li₂Mn₃MO₈ (wherein, M=Fe, Co, Ni, Cu, or Zn); LiMn₂O₄ where a part of Li of chemical formula is substituted with an alkaline-earth metal ion; a disulfide compound; Fe₂(MoO₄)₃, and the like, but is not limited thereto.

Examples of the conductive material may be carbon black such as ketjen black, acetylene black, and the like, natural graphite, artificial graphite, and the like, but is not particularly limited as long as it may increase conductivity of the positive electrode.

The binder may be for example polyvinylidene fluoride, an ethylene-propylene-diene terpolymer, a styrene-butadiene rubber, an acrylonitrile-butadiene rubber, a fluorine rubber, polyvinyl acetate, polymethylmethacrylate, polyethylene, nitrocellulose, and the like, but is not particularly limited as long as it may bind the (positive or negative) active material and the conductive material on the current collector. Examples of the binder may be polyvinyl alcohol, carboxymethyl cellulose (CMC), starch, hydroxypropyl cellulose, recycled cellulose, tetrafluoroethylene, polyethylene, polypropylene, an ethylene-propylene-diene terpolymer (EPDM), sulfonated EPDM, a styrene-butene rubber, a fluorine rubber, various copolymers, polymeric highly saponified polyvinyl alcohol, and the like, in addition to the foregoing materials.

The negative active material may be for example carbon and graphite materials such as natural graphite, artificial graphite, expanded graphite, carbon fiber, non-graphitic carbon, carbon black, carbon nanotube, fullerene, activated carbon, and the like; a metal such as Al, Si, Sn, Ag, Bi, Mg, Zn, In, Ge, Pb, Pd, Pt, Ti, and the like that may be an alloy with lithium and a compound including such an element; a composite material of a metal and a compound thereof and carbon and graphite materials; a lithium-containing nitride, and the like. Among them, carbon-based active materials, silicon-based active materials, tin-based active materials, or silicon-carbon-based active materials may be desirably used and may be used alone or in a combination of two or more.

The separator is not particularly limited and may be any separator of a rechargeable lithium battery. For example, a porous film or non-woven fabric having excellent high rate discharge performance may be used alone or in a mixture thereof. The separator may include pores and the pores may have generally a pore diameter of about 0.01 to about 10 μm and a thickness of about 5 to about 300 μm. A substrate of the separator may include, for example, a polyolefin-based resin, a polyester-based resin, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, and the like. When the electrolyte is a solid electrolyte such as a polymer, the solid electrolyte may function as a separator.

The conductive material is a component to further improve conductivity of an active material and may be included in an amount of about 1 wt % to about 30 wt % based on a total weight of the electrode, but is not limited thereto. Such a conductive material is not particularly limited as long as it does not cause chemical changes of a battery and has conductivity, and may be for example, graphite such as natural graphite or artificial graphite; carbon black such as carbon black, acetylene black, ketjen black, channel black, furnace black, lamp black, summer black, and the like; a carbon derivative such as carbon nanotube, fullerene, and the like, a conductive fiber such as a carbon fiber or a metal fiber, and the like; carbon fluoride, a metal powder such as aluminum, a nickel powder, and the like; a conductive whisker such as zinc oxide, potassium titanate, and the like; a conductive metal oxide such as a titanium oxide; a conductive material such as a polyphenylene derivative, and the like.

The filler is an auxiliary component to suppress expansion of an electrode, is not particularly limited as long as it does not cause chemical changes of a battery and is a fiber-shaped material, and may be for example, an olefin-based polymer such as polyethylene, polypropylene, and the like; a fiber-shaped material such as a glass fiber, a carbon fiber, and the like.

In the electrode, the current collector may be a site where electron transports in an electrochemical reaction of the active material and may be a negative current collector and a positive current collector according to types of the electrode. The negative current collector may have a thickness of about 3 μm to about 500 μm. The negative current collector is not particularly limited as long as it does not cause chemical changes of a battery and has conductivity and may be, for example, copper, stainless steel, aluminum, nickel, titanium, fired carbon, copper or stainless steel that is surface-treated with carbon, nickel, titanium, silver, or the like, an aluminum-cadmium alloy, and the like.

The positive current collector may have a thickness of about 3 μm to about 500 μm, but is not limited thereto. Such a positive current collector is not particularly limited as long as it does not cause chemical changes of a battery and has high conductivity and may be, for example, stainless steel, aluminum, nickel, titanium, fired carbon, or aluminum or stainless steel that is surface-treated with carbon, nickel, titanium, silver, or the like.

The current collectors may have a fine concavo-convex on its surface to reinforce a binding force of the active material and may be used in various shapes of a film, a sheet, a foil, a net, a porous film, a foam, a non-woven fabric, or the like.

The lithium-containing non-aqueous electrolyte solution may consist of a non-aqueous electrolyte and a lithium salt.

The non-aqueous electrolyte may be, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and the like.

The lithium salt is a material that is dissolved in the non-aqueous electrolyte solution and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloro borane, lower aliphatic lithium carbonate, lithium phenyl borate, imide, and the like.

An organic solid electrolyte, an inorganic solid electrolyte, and the like may be used as needed.

The organic solid electrolyte may be, for example, polyethylene derivative, a polyethylene oxide derivative, a polypropylene oxide derivative, a phosphoric acid ester polymer, a poly agitation lysine, polyester sulfide, polyvinyl alcohol, polyvinylidene fluoride, a polymer including an ionic leaving group, and the like.

The inorganic solid electrolyte may be, for example, nitrides of Li such as Li₃N, LiI, Li₅Nl₂, Li₃N—LiI—LiOH, Li₂SiS₃, Li₄SiO₄, Li₄SiO₄—LiI—LiOH, Li₃PO₄—Li₂S—SiS₂, and the like, halides, sulfates, and the like.

The non-aqueous electrolyte solution may include, for example, pyridine, triethylphosphite, triethanolamine, cyclic ether, ethylene diamine, diglyme, hexaphosphoric tris-amide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride in order to improve charge and discharge characteristics, flame retardancy, and the like. As needed, in order to endow inflammability, a halogen-containing solvent such as carbon tetrachloride, ethylene trifluoride, and the like may be further added and in order to improve high temperature storage characteristics, carbon dioxide gas may be further added.

As described above, a battery including a battery case according to an embodiment does not need manufacture of a unit cell including exterior materials consisting of additional moisture transmission resistance materials on each electrode assembly, and thus an electrode assembly housed in the container of the battery case does not need additional exterior materials.

Hereinafter, the embodiments are described with reference to examples and comparative examples. The following examples and comparative examples are exemplary but do not limit the scope of the present disclosure.

### EXAMPLES

### Synthesis Example: Manufacture of Surface Treated Carbon-Based Filler

The carbon-based filler for each of Examples 1-9 is prepared as follows. In accordance with Table 1, 10 grams (g) of an expanded graphite (TIMREX® C-Therm011, manufactured by Imerys) having an average particle diameter of greater than or equal to about 10 micrometers (μm) and an aspect ratio of about 100, is combined with a surface treatment agent, i.e., an oligomer or polymer as follows; 0.5 g of (1) Disperbyk 2009 (amine value 4 mg KOH/g), 0.5 g of (2) Disperbyk 2150 (amine value 57 mg KOH/g), 0.5 g of (3) Disperbyk 2155 (amine value 48 mg KOH/g), 0.5 g of (4) Disperbyk 2013 (amine value 18 mg KOH/g), and 0.5 g of (5) Disperbyk 2205 (amine value 27 mg KOH/g), manufactured by BYK and added to acetone (solubility parameter: 19.9 MPa^{1/2}) and dispersed. The dispersion is aged at a room temperature for about 24 hours, and then the graphite with the surface-treatment agent adsorbed on the surface is washed, alternatively, using acetone and toluene and filtered by vacuum-filtering, and then dried at 150° C. for 30 minutes to obtain a surface-treated graphite as a carbon-based filler.

### Example 1 to 9 and Comparative Example 1 to 9: Manufacture and Evaluation of Specimen

The carbon-based filler of the surface-treated graphite obtained from Synthesis Example, a liquid crystal polymer (LCP) or a high density polyethylene (HDPE) as a base polymer, are each preliminarily mixed at the amounts shown in Table 1. Each of the mixtures is then introduced through a hoper of a twin screw extruder and melt-extruded while passing the extruder at 300° C. and 30 rpm. The extruded article is cut by a pelletizer to provide a composite pellet. In the Examples, the liquid crystal polymer (LCP) is obtained by copolymerizing 40 mole percent (mol %) of HBA (hydroxybenzoic acid), 30 mol % of IPA (isophthalic acid), 20 mol % of HQ (hydroquinone), and 10 mol % of BP (4,4′-biphenol); and the high density polyethylene (HDPE) has a weight average molecular weight of greater than or equal to about 10⁵ grams per mole (g/mol).

Each of the obtained pellets is prepared for a specimen (circular molded article having a thickness of about 1 mm and a diameter of 30 mm for measuring a water vapor transmittance rate (WVTR). Examples 1 to 8 components and contents are shown in Table 1. In addition, the specimen according to Example 9 is prepared in accordance with the same components as in Example 1 of Table 1, except that the amount of the base polymer is decreased to 87 wt %, and 3 wt % of CaO is further added as an inorganic moisture absorbent.

A polymer specimen according to Comparative Example 1 is prepared with the liquid crystal polymer as the base polymer and without the addition of the carbon-based filler or the inorganic moisture absorbent, and the mixture is melt-extruded and formed into pellets as above. A specimen according to Comparative Example 2 is prepared by adding the graphite as a carbon-based filler into the liquid crystal polymer, while including 10 wt % of the graphite before treating the surface instead of the surface-treated graphite according to Synthesis Example, and injection-molding the same. In addition, a specimen according to Comparative Example 3 is prepared in accordance with the same procedure as in Comparative Example 2, except that the amount of the graphite before the surface treatment is decreased into 5 wt %.

Specimens according to Comparative Examples 4 to 6 are prepared by including each of 20 wt %, 50 wt %, and 55 wt %, respectively, of the graphite before the surface treatment and the high density polyethylene and injection-molding the same. A specimen according to Comparative Example 7 is prepared by including 45 wt % of the high density polyethylene and 55 wt % of the surface-treated graphite according to Synthesis Example 1 and injection-molding the same.

Lastly, a specimen according to Comparative Example 8 is prepared by including 87 wt % of the liquid crystal polymer, 10 wt % of the graphite before the surface treatment, and 3 wt % of an inorganic moisture absorbent of CaO, and injection-molding the same. A specimen according to Comparative Example 9 is prepared by including 90 wt % of the liquid crystal polymer and 10 wt % of the inorganic moisture absorbent of only CaO without adding the carbon-based filler and injection-molding the same. The components for each of the Examples 1 to 9 and Comparative Examples 1 to 9 are listed in Table 1.

The specimens according to Examples 1 to 9 and Comparative Examples 1 to 9 are measured for a component, an amount, a tensile strength, an impact strength, WVTR, a thermal conductivity, and the like, as follows, and the results are shown in Table 1.

The water vapor transmittance rate (WVTR) is measured using a Mocon Aquatran2, according to ISO15106-3 at 38° C. and a relative humidity of 100%.

In addition, the impact strength is measured using an Instron (impactor II, CEAST 9050), according to ASTM D265, and un-notched type Izod Impact strength.

The tensile strength is measured in accordance with ASTM D638 using a Universal Testing Machine (UTM).

Thermal conductivity in a vertical direction (thermal conductivity-T) and thermal conductivity in a horizontal direction (thermal conductivity-I) are measured by a laser flash method.

TABLE 1

| | | | | | | | | | Thermal | Thermal |
|---|---|---|---|---|---|---|---|---|---|---|
| | | | | Surface | CaO | Tensile | Impact | | conduct. | conduct. |
| | Matrix | | Graphite | treat agent | (wt %) | strength | strength | WVTR | (T) | (I) |
| | Types | wt % | wt % | (DYK-#) | wt % | Kgf/cm² | KJ/m² | g/m²day | W/m · K | W/m · K |
| Comp. | LCP | 100 | 0 | — | — | 1711 | 22 | 0.023 | 0.13 | 0.84 |
| Ex. 1 | | | | | | | | | | |
| Comp. | | 90 | 10 | — | — | 1523 | 16.0 | 0.031 | 0.22 | 1.42 |
| Ex. 2 | | | | | | | | | | |
| Ex. 1 | | 90 | 10 | DYK 2013 | — | 1384 | 26.0 | 0.007 | 0.29 | 1.77 |
| Comp. | LCP | 95 | 5 | — | — | 1475 | 19.4 | 0.028 | — | — |
| Ex. 3 | | | | | | | | | | |
| Ex. 2 | | 95 | 5 | DYK 2009 | — | 1378 | 24.5 | 0.012 | — | — |
| Ex. 3 | | 95 | 5 | DYK 2150 | — | 1459 | 25.6 | 0.013 | — | — |
| Ex. 4 | | 95 | 5 | DYK 2013 | — | 1609 | 27.9 | 0.010 | — | — |
| Ex. 5 | | 95 | 5 | DYK 2155 | — | 1543 | 22.5 | 0.015 | — | — |
| Ex. 6 | | 95 | 5 | DYK 2205 | — | 1542 | 21.9 | 0.013 | — | — |
| Comp. | HDPE | 80 | 20 | — | — | 306 | 6.9 | 0.161 | 0.57 | 0.77 |
| Ex. 4 | | | | | | | | | | |
| Comp. | | 50 | 50 | — | — | 349 | 2.6 | 0.085 | 1.54 | 1.68 |
| Ex. 5 | | | | | | | | | | |
| Comp. | | 45 | 55 | — | — | Processing is | | — | — | |
| Ex. 6 | | | | | | impossible | | | | |
| Ex. 7 | | 80 | 20 | DYK 2150 | — | 321 | 7.2 | 0.115 | 0.69 | 0.92 |
| Ex. 8 | | 50 | 50 | | — | 355 | 2.8 | 0.048 | 1.73 | 2.17 |
| Comp. | | 45 | 55 | | — | Processing is | | — | — | |
| Ex. 7 | | | | | | impossible | | | | |
| Comp. | LCP | 87 | 10 | — | 3 | 1427 | 13.7 | 0.012 | 0.22 | 1.44 |
| Ex. 8 | | | | | | | | | | |
| Comp. | | 90 | — | — | 10 | 1446 | 2.5 | 0.0005 | 0.12 | 0.82 |
| Ex. 9 | | | | | | | | | | |
| Ex. 9 | | 87 | 10 | DYK 2013 | 3 | 1504 | 25.1 | 0.0008 | 0.31 | 1.81 |

As shown in Table 1, it is understood that the water vapor transmittance rates (WVTR) of the specimens according to Comparative Examples 2 and 3 including the graphite before the surface treatment tend to maintain the WVTR of the base polymer of the liquid crystal polymer, or can exhibit a slight increase in WVTR. In contrast, Examples 1 to 6 that include a surface-treated graphite, exhibits a very significant decrease I WVTR depending upon the graphite content or the type of surface-treatment agent. For example, compare WVTR of Ex. 1 with Comp. Ex. 2 (a percent decrease of about 77%), and compare Examples 2-6 with Comp. Ex. 3 (a percent decrease of about 45% to 65%), thereby demonstrating a significant decrease in WVTR or a significant improvement in moisture transmission resistance. In addition, the impact strength of the specimens according to Comparative Examples 2 and 3 including graphite before the surface treatment decreases compared to Comparative Example 1 including no carbon-based filler. Moreover, the impact strength of the specimen according to Examples 1 to 6 including the surface-treated graphite appear to maintain a similar level or value to the impact strength of Comparative Example 1 including only the liquid crystal polymer, though many of the Examples exhibit a slight increase in impact strength. It is believed that due to the surface-treatment agent adsorbed on the filler surface, the voids among the interface may be decreased by the high affinity (compatibility) at the interface between the filler and the base polymer, thereby the moisture transmission resistance of the molded article may be improved, and the impact strength may be maintained or increase slightly.

Thermal conductance is defined as the quantity of heat that passes in unit time through a plate of particular area and thickness when its opposite faces differ in temperature by one kelvin and is measured in watts per meter kelvin (W/mK).

The polymer specimen according to Comparative Example 1 including no carbon-based filler and molded with only the liquid crystal polymer has a vertical direction thermal conductivity (thermal conductivity-T) of 0.13 W/mK and a horizontal direction thermal conductivity (thermal conductivity-I) of 0.84 W/mK. On the other hand, the specimen according to Comparative Example 2 including 10 wt % of graphite before the surface treatment has a vertical direction thermal conductivity (thermal conductivity-T) of 0.22 W/mK and a horizontal direction thermal conductivity (thermal conductivity-I) of 1.42 W/mK, so the thermal conductivity is improved compared to Comparative Example 1, which has no carbon-based filler.

Example 1 including the surface-treated graphite has a vertical direction thermal conductivity (thermal conductivity-T) of 0.29 W/mK and the horizontal direction thermal conductivity of 1.77 W/mK, so it is understood that both the horizontal and the vertical directions are improved by as much as greater than or equal to 2 times of the specimen according to Comparative Example 1, and the vertical direction thermal conductivity is improved in about 30%, and the horizontal direction thermal conductivity is improved in about 20% compared to Comparative Example 2. In other words, without being bound by theory, it is believed that the voids are decreased in the interface between the filler and the base polymer due to the surface-treatment agent, so the thermal conductivity is also improved.

In addition, Comparative Examples 4 to 7 and Examples 7 and 8, each of which includes high density polyethylene (HDPE) instead of the liquid crystal polymer as the base polymer, exhibit properties equivalent to the cases including the liquid crystal polymer as the base polymer. However, due to the basic physical property difference of the base polymer itself, the moisture transmission resistance or the mechanical properties is lower than the case of using the liquid crystal polymer. However, the water vapor transmittance rate (WVTR) of the specimens according to Examples 7 and 8 including the same amount of the polymer and the surface-treated graphite as Comparative Examples 4 and 5, which include 20 wt % and 50 wt % of graphite before the surface treatment, respectively, exhibit a decrease of 30% and 45%, respectively, and the mechanical properties such as the tensile strength and the impact strength are slightly increased. Also, the thermal conductivity in Examples 8 and 9 exhibits an increase in both the vertical direction and the horizontal direction thermal conductivity compared to Comparative Examples 4 and 5. Meanwhile, as demonstrated with Comparative Examples 6 and 7, the molding article may not be technically obtained if the amount of the carbon-based filler is greater than 50 wt % such as 55 wt %, which is greater than the base polymer.

In the specimen according to Comparative Example 8 including the liquid crystal polymer as the base polymer and including 10 wt % of graphite before the surface treatment, and further including 3 wt % of the inorganic moisture absorbent, by including the inorganic moisture absorbent, the WVTR is shown to decrease by about 50%, and the impact strength is also shown to decrease by about 50%, compared to the specimen according to Comparative Example 1, which is prepared by injection-molding only the liquid crystal polymer. In the specimen according to Comparative Example 9 including 90 wt % of the liquid crystal polymer as the base polymer and 10 wt % of only the inorganic moisture absorbent without adding the carbon-based filler, the WVTR is shown to decrease due to the increase of the inorganic moisture absorbent content, so the moisture transmission resistance is significantly increased. However, the impact strength is shown to decrease in greater than or equal to 65% compared to Comparative Example 8, and the impact strength is significantly decreased in a level of about 10% compared to the specimen of Comparative Example 1 including only the liquid crystal polymer. The thermal conductivity of the specimen according to Comparative Example 9 is similar to the specimen according to Comparative Example 1.

In contrast, according to Example 9 including 87% of the liquid crystal polymer, 10 wt % of the surface-treated graphite, and 3 wt % of the inorganic moisture absorbent, the WVTR is shown to significantly decrease to a similar level of the specimen according to Comparative Example 9 including 10 wt % of the inorganic moisture absorbent, however, the impact strength is equivalent to the specimen of Comparative Example 1 including only the liquid crystal polymer or slightly increased. In a case of the thermal conductivity, both the vertical direction and the horizontal direction thermal conductivity are shown to increase in greater than or equal to about 2 times of the specimen according to Comparative Example 1.

In summary, the composite including the base polymer and the surface-treated carbon-based filler according to an embodiment, the mechanical properties are maintained or increased while the moisture transmission resistance is increased, and the thermal conductivity is also increased. On the other hand, if a comparative composite including only the carbon-based filler of which the surface is not treated, both the moisture transmission resistance and the mechanical properties are shown to decrease or deteriorate, and only the thermal conductivity is partially increased. In the case of including only the inorganic moisture absorbent without the carbon-based filler, the moisture transmission resistance is increased, but the mechanical properties are significantly shown to decrease or deteriorate, and the thermal conductivity is also deteriorated. Furthermore, if the composite according to an embodiment further includes an inorganic moisture absorbent, the mechanical properties are maintained while the moisture transmission resistance is shown to significantly improve, and the thermal conductivity is further enhanced.

As in above, according to an embodiment, the composite including a base polymer, a carbon-based filler, and a surface-treatment agent which is an oligomer or polymer having affinity for both the base polymer and the carbon-based filler may be usable for preparing a battery case for a rechargeable lithium battery and the like requiring excellent mechanical properties, moisture transmission resistance and thermal conductivity.

While this disclosure has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A battery case comprising
a container configured to house an electrode assembly, wherein the container comprises a bottom wall and a plurality of side walls, the bottom wall and the side walls are integrated to have an open side opposite the bottom wall, and to provide a space for housing the electrode assembly,
the container comprises a composite of a base polymer, a carbon-based filler, and an oligomer or a polymer that is dissolved in a solvent, the solvent having a solubility parameter of about 15 MPa^{1/2} to about 30 MPa^{1/2}, and the oligomer or polymer has an amino group or a hydrophobic functional group,
wherein the battery case has a water vapor transmission rate measured at a thickness of 1 millimeter, at 38° C., and relative humidity of 100% of less than about 0.07 grams per square meter per day according to ISO 15106 or ASTM F1249.

2. The battery case of claim 1, wherein the base polymer comprises polycarbonate, polyolefin, polyvinyl, polyamide, polyester, polyphenylene sulfide, polyphenylene ether, polyphenylene oxide, polystyrene, polyamide, a polycyclic olefin copolymer, an acrylonitrile-butadiene-styrene copolymer, a liquid crystal polymer, a mixture thereof, an alloy thereof, or a copolymer thereof.

3. The battery case of claim 1, wherein the base polymer comprises a high density polyethylene or a liquid crystal polymer.

4. The battery case of claim 1, wherein the liquid crystal polymer comprises a liquid crystal aromatic polyester comprising a structural unit represented by Chemical Formula 1; a structural unit represented by Chemical Formula 2 and a structural unit represented by Chemical Formula 3; or a structural unit represented by Chemical Formula 1, a structural unit represented by Chemical Formula 2, and a structural unit represented by Chemical Formula 3:
*-(—(C═O)—Ar¹—O—)-* Chemical Formula 1
*-(—(C═O)—Ar²—(C═O)—)-* Chemical Formula 2
*-(—O—Ar³—O—)-* Chemical Formula 3
wherein, in Chemical Formulae 1 to 3,
Ar¹, Ar², and Ar³ are each independently a substituted or unsubstituted C6 to C30 single aromatic ring group, a condensed ring of two or more substituted or unsubstituted C6 to C30 aromatic ring groups, or a group comprising two or more substituted or unsubstituted C6 to C30 aromatic ring groups that are linked by a single bond, —O—, —C(═O)—, —C(OH)₂—, —S—, or —S(O)₂—.

5. The battery case of claim 1, wherein the liquid crystal polymer comprises a liquid crystal aromatic polyamide comprising a structural unit represented by Chemical Formula 4; a structural unit represented by Chemical Formula 5 and a structural unit represented by Chemical Formula 2; or a structural unit represented by Chemical Formula 4, a structural unit represented by Chemical Formula 5, and a structural unit represented by Chemical Formula 2:
*-(—(C═O)—Ar⁴—NH—)-* Chemical Formula 4
*-(—NH—Ar⁴—NH—)-* Chemical Formula 5
*-(—(C═O)—Ar²—(C═O)—)-* Chemical Formula 2
wherein, in Chemical Formula 4, Chemical Formula 5, and Chemical Formula 2,
Ar⁴, Ar^{y}, and Ar² are each independently a substituted or unsubstituted C6 to C30 single aromatic ring group, a condensed ring of two or more substituted or unsubstituted C6 to C30 aromatic ring groups, or a group comprising two or more substituted or unsubstituted C6 to C30 aromatic ring groups that are linked by a single bond, —O—, —C(═O)—, —C(OH)₂—, —S—, or —S(O)₂—.

6. The battery case of claim 1, wherein the carbon-based filler comprises graphite, graphene, a graphite nanoplate, or a combination thereof.

7. The battery case of claim 1, wherein the carbon-based filler has a plate-like shape having an aspect ratio of greater than or equal to about 10.

8. The battery case of claim 1, wherein the hydrophobic functional group of the oligomer or polymer is an aliphatic hydrocarbon group, an alicyclic hydrocarbon group, an aromatic hydrocarbon group, a (meth)acryloyl group, a halogen-substituted aliphatic, a halogen-substituted alicyclic, or a halogen-substituted aromatic hydrocarbon group, or a combination thereof.

9. The battery case of claim 1, wherein the oligomer or polymer comprises an amino group, and has an amine value of about 1 milligram KOH per gram to about 100 milligram KOH per gram.

10. The battery case of claim 1, wherein a total amount of the carbon-based filler and the oligomer or polymer in the composite is less than or equal to about 50 weight percent, based on a total weight of the composite.

11. The battery case of claim 1, wherein the oligomer or polymer is included in an amount of less than or equal to about 50 parts by weight per 100 parts by weight of the carbon-based filler.

12. The battery case of claim 1, wherein the base polymer comprises a liquid crystal polymer, and the carbon-based filler and the oligomer or polymer are included in an amount of less than about 20 weight percent, based on a total weight of the composite.

13. The battery case of claim 1, wherein the base polymer comprises a high density polyethylene, and the carbon-based filler and the oligomer or polymer are included in an amount of less than or equal to about 50 weight percent, based on a total weight of the composite.

14. The battery case of claim 1, wherein the composite further comprises an inorganic moisture absorbent comprising a silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, CaCO₃, K₂CO₃, CaCl₂, Ba(ClO₄)₂, Ca, or a combination thereof.

15. The battery case of claim 14, wherein the inorganic moisture absorbent is included in an amount of less than or equal to about 20 weight percent, based on a total weight of the composite.

16. The battery case of claim 1, wherein the composite further comprises a crystal of the base polymer, or a crystal of a polymer different from the base polymer, an inorganic material particle that is different from the inorganic moisture absorbent, a fiber-shaped material, or an additional moisture barrier material different from the carbon-based filler.

17. The battery case of claim 16, wherein the additional moisture barrier material comprises wollastonite, mica, an inorganic whisker, barium sulfate, kaolin, talc, nanoclay, a carbon fiber, a glass fiber, or a mixture thereof.

18. The battery case of claim 1, wherein the battery case further comprises a lid configured to cover at least a portion of the open side of the container, and having at least one of a positive terminal and a negative terminal.

19. The battery case of claim 1, wherein the container comprises a plurality of cell compartments separated by at least one partition wall disposed in the space.

20. A battery comprising
the battery case of claim 1, and
an electrode assembly comprising a positive electrode and a negative electrode housed in the container of the battery case.
